(19) United States
(12) Patent Application Publication
(10) Pub. No.: US 2026/0213155 A1
(43) Pub. Date: Jul. 23, 2026

(54) NEGATIVE ELECTRODE SHEET, SECONDARY BATTERY, AND ELECTRONIC DEVICE

(71) Applicant: Ningde Amperex Technology Limited, Ningde (CN)

(72) Inventor: Xiuyang ZHU, Ningde (CN)

(73) Assignee: Ningde Amperex Technology Limited, Ningde (CN)

(21) Appl. No.: 19/457,389

(22) Filed: Jan. 23, 2026

(30) Foreign Application Priority Data
Jan. 23, 2025 (CN) 202510111763.1

(51) Int. Cl. H01M 4/133; H01M 4/02; H01M 4/583; H01M 4/66

(52) U.S. Cl. CPC H01M 4/133; H01M 4/583; H01M 4/661; H01M 4/667; H01M 2004/021; H01M 2004/027

(57) ABSTRACT

A negative electrode sheet includes a negative electrode current collector and a negative electrode material layer. Along a length direction of the unfolded negative electrode sheet, the negative electrode sheet includes a blank foil region and a single-sided negative electrode material layer region connected to the blank foil region. Based on a length of the negative electrode sheet, a length proportion of the blank foil region is A, and a length proportion of the single-sided negative electrode material layer region is B, where 1/60≤A≤1/11, and 1/20≤B≤1/5. Grooves are provided on the negative electrode material layer in the single-sided negative electrode material layer region, the grooves extend in a width direction of the unfolded negative electrode sheet and are spaced apart along the length direction of the unfolded negative electrode sheet.

### CROSS REFERENCE TO RELATED APPLICATIONS

The present application claims priority to Chinese Patent Application No. 202510111763.1, filed on Jan. 23, 2025, the disclosure of which is hereby incorporated by reference in its entirety.

### TECHNICAL FIELD

The present application relates to the field of electrochemical technologies, and in particular to a negative electrode sheet, a secondary battery, and an electronic device.

### BACKGROUND

Secondary batteries, such as lithium-ion batteries, possess characteristics of high specific energy, high operating voltage, low self-discharge rate, small volume, and light weight, and are widely applied in the field of consumer electronics. With the widespread application of lithium-ion batteries, the market imposed increasingly stringent requirements for the performance of lithium-ion batteries.

Currently, the wound structure is the most mature structural process for lithium-ion batteries. Generally, a negative electrode sheet with a single-sided active material layer is used as the initial winding in the wound structure to increase the proportion of active material and improve the energy density of the secondary battery. However, the negative electrode sheet in the single-sided negative electrode material layer region exhibits obvious stress concentration after cold pressing, which results in obvious curling of the negative electrode sheet. The curled single-sided negative electrode sheet structure impairs the electrode assembly structure and the adhesion of the adhesive tape during the winding process, and strip breakage is prone to occur at the boundary between the double-sided and single-sided regions.

### SUMMARY

The purpose of the present application is to provide a negative electrode sheet, a secondary battery, and an electronic device, so that curling of the single-sided region negative electrode sheet is mitigated, the risk of feeding folding and strip breakage of the single-sided region negative electrode sheet during the manufacturing process is reduced, and the wettability of the electrolyte to the single-sided region negative electrode sheet is improved, thereby enhancing the kinetic performance and safety performance of the secondary battery.

It should be noted that in the summary of the present application, a lithium-ion battery is used as an example of a secondary battery to explain the present application, but the secondary battery of the present application is not limited to a lithium-ion battery. The specific technical solution is as follows.

A first aspect of the present application provides a negative electrode sheet, including a negative electrode current collector and a negative electrode material layer. Along a length direction of the unfolded negative electrode sheet, the negative electrode sheet includes a blank foil region and a single-sided negative electrode material layer region connected to the blank foil region. Based on a length of the negative electrode sheet, a length proportion of the blank foil region is A, and a length proportion of the single-sided negative electrode material layer region is B, where 1/60≤A≤1/11, preferably 1/30≤A≤1/11; and 1/20≤B≤1/5, preferably 1/14≤B≤1/5. A plurality of grooves are provided on the negative electrode material layer in the single-sided negative electrode material layer region, and the grooves are spaced apart along the length direction of the negative electrode sheet. By providing the grooves on the single-sided negative electrode material layer region and applying the resulting negative electrode sheet to a secondary battery, curling of the single-sided negative electrode material layer region can be mitigated, the risk of feeding folding and strip breakage of the single-sided negative electrode material layer region during the manufacturing process can be reduced, and the wettability of the electrolyte to the single-sided negative electrode material layer region can be improved, thereby enhancing the kinetic performance and safety performance of the secondary battery.

In some embodiments of the present application, along a thickness direction of the negative electrode sheet, a single groove has an orthographic projection on the negative electrode material layer; along the length direction of the negative electrode sheet, a length of the single-sided negative electrode material layer region is L mm; and the negative electrode sheet further includes a double-sided negative electrode material layer region, where the single-sided negative electrode material layer region and the double-sided negative electrode material layer region have a boundary line, a shortest distance between an outer contour of the orthographic projection of the single groove and the boundary line is L₁ mm, and 1/2≤(L-L₁)/L≤1. In some embodiments of the present application, along a width direction of the unfolded negative electrode sheet, the single-sided negative electrode material layer region includes a middle region and two edge regions connected to the middle region, where the grooves are distributed at intervals in the two edge regions and separately extend through the two edge regions; and based on a width of the negative electrode material layer in the single-sided negative electrode material layer region, a length proportion of the middle region is C, and 0%≤C≤30%. The above arrangement helps mitigate the curling of the single-sided negative electrode material layer region, thereby reducing the risk of strip breakage and feeding folding of the single-sided region negative electrode sheet during actual processing, and also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

In some embodiments of the present application, at least one of the following characteristics is satisfied: (1) the negative electrode current collector includes a copper foil, and a thickness of the copper foil is H m, where 4≤H≤8; or (2) a coating weight per unit area of the negative electrode material layer in the single-sided negative electrode material layer region is m mg/1540.25 mm², where 100≤m≤200. The above arrangement helps mitigate the curling of the single-sided negative electrode material layer region, thereby further reducing the risk of strip breakage and feeding folding of the single-sided region negative electrode sheet during actual processing.

In some embodiments of the present application, along a width direction of the negative electrode sheet, a width of the negative electrode sheet is D mm; and along the length direction of the negative electrode sheet, a length of the single-sided negative electrode material layer region is L mm, where 1≤L/D≤2, and 50≤D≤130. By regulating the values of L/D and D within the above ranges, it helps mitigate the curling of the single-sided negative electrode material layer region, thereby further reducing the risk of strip breakage and feeding folding of the single-sided region negative electrode sheet during actual processing. In addition, the width of the negative electrode sheet and the length of the single-sided negative electrode material layer region are related to the shape of the electrode assembly formed after winding, and regulating the shape of the electrode assembly helps maintain the actual production efficiency and processing performance.

In some embodiments of the present application, the negative electrode sheet further includes a double-sided negative electrode material layer region, the negative electrode material layer includes a negative electrode active material, and the negative electrode active material includes at least one of graphite or a silicon-carbon composite material; where a compacted density of the negative electrode material layer in the single-sided negative electrode material layer region is PD₁ g/cm³, a compacted density of the negative electrode material layer in the double-sided negative electrode material layer region is PD₂ g/cm³, and 0.95≤PD₁/PD₂≤1. In some embodiments of the present application, 1.5≤PD₂≤1.8. The above arrangement, while maintaining the energy density of the secondary battery, achieves a more pronounced effect in reducing deformation caused by residual stress from cold pressing in the single-sided negative electrode material layer region more obvious, and mitigates the curling of the single-sided negative electrode material layer region, thereby further reducing the risk of strip breakage and feeding folding of the single-sided region negative electrode sheet during actual processing.

In some embodiments of the present application, along a thickness direction of the negative electrode sheet, an average depth of the plurality of grooves is h m, where 5≤h≤30. By regulating the value of h within the above range, it helps mitigate the curling of the single-sided negative electrode material layer region, thereby reducing the risk of strip breakage and feeding folding of the single-sided region negative electrode sheet during actual processing. In addition, the actual production efficiency is maintained and processing is facilitated without the groove depth being excessively large.

In some embodiments of the present application, the plurality of grooves are distributed in a strip shape; and along the thickness direction of the negative electrode sheet, a single groove has an orthographic projection on the negative electrode material layer, satisfying at least one of the following conditions: (1) an average width of the orthographic projections of the plurality of grooves is d m, where 50≤d≤110; or (2) a shortest distance between outer contours of the orthographic projections of two adjacent grooves is L₂ mm, where 0.5≤L₂≤1.5. In some embodiments of the present application, an included angle between the center line of a single groove and the length direction of the negative electrode sheet is α°, where 20≤α≤75. The above arrangement helps mitigate the curling of the single-sided negative electrode material layer region, thereby reducing the risk of strip breakage and feeding folding of the single-sided region negative electrode sheet during actual processing. In addition, it helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

In some embodiments of the present application, along the thickness direction of the negative electrode sheet, a total area of the orthographic projections of the plurality of grooves is S₁ mm², a projected area of the single-sided negative electrode material layer region is S₂ mm², and 2%≤S₁/S₂≤10%. By regulating the value of S₁/S₂ within the above range, the overall rigidity of the single-sided material layer region can be enhanced, thereby helping mitigate the curling of the single-sided negative electrode material layer region, and reducing the risk of strip breakage and feeding folding of the single-sided region negative electrode sheet during actual processing.

A second aspect of the present application provides a secondary battery including the negative electrode sheet according to any one of the above embodiments. Applying the negative electrode sheet of the present application to a secondary battery mitigates the curling of the single-sided region negative electrode sheet, reduces the risk of feeding folding and strip breakage of the single-sided region negative electrode sheet during the manufacturing process, and improves the wettability of the electrolyte to the single-sided region negative electrode sheet, thereby enhancing the kinetic performance and safety performance of the secondary battery.

In some embodiments of the present application, the secondary battery has a wound structure, and the blank foil region and the single-sided negative electrode material layer region are located at the starting end of the wound structure.

A third aspect of the present application provides an electronic device including the secondary battery according to any one of the above embodiments, so that the electronic device provided by the present application has good performance.

Beneficial effects of the present application:

The present application provides a negative electrode sheet, a secondary battery, and an electronic device. The negative electrode sheet includes a negative electrode current collector and a negative electrode material layer. Along a length direction of the negative electrode sheet, the negative electrode sheet includes a blank foil region and a single-sided negative electrode material layer region connected to the blank foil region. Based on a length of the negative electrode sheet, a length proportion of the blank foil region is A, and a length proportion of the single-sided negative electrode material layer region is B, where 1/60≤A≤1/11, and 1/20≤B≤1/5. A plurality of grooves are provided on the negative electrode material layer in the single-sided negative electrode material layer region, and the grooves are spaced apart along the length direction of the negative electrode sheet. By providing grooves on the single-sided region negative electrode sheet, the curling of the single-sided region negative electrode sheet can be mitigated, the risk of feeding folding and strip breakage of the single-sided region negative electrode sheet during the manufacturing process can be reduced, and the wettability of the electrolyte to the single-sided region negative electrode sheet can be improved, thereby enhancing the kinetic performance and safety performance of the secondary battery.

Certainly, implementing any product or method of the present application does not necessarily need to achieve all the advantages described above at the same time.

### DESCRIPTION OF DRAWINGS

In order to more clearly illustrate the embodiments of the present application or the technical solutions in the prior art, the accompanying drawings required for use in the embodiments or prior art descriptions will be briefly introduced below. Obviously, the accompanying drawings in the following description are merely some embodiments of the present application, and those of ordinary skill in the art can obtain other embodiments based on these drawings.

FIG. 1 is a schematic diagram of a wound structure formed by an electrode assembly according to an embodiment of the present application;

FIG. 2 is a partial front view of the negative electrode sheet after the electrode assembly in FIG. 1 is unfolded; and

FIG. 3 is a schematic longitudinal cross-sectional structural view of FIG. 2 along a thickness direction of the negative electrode sheet.

Reference signs are as follows:
electrode assembly 001; positive electrode sheet 10; negative electrode sheet 20; separator 30; positive electrode current collector 11; positive electrode material layer 12; negative electrode current collector 21; negative electrode material layer 22; blank foil region 210; single-sided negative electrode material layer region 220; double-sided negative electrode material layer region 230; groove 2201.

### DETAILED DESCRIPTION OF EMBODIMENTS

The technical solutions in the present application will be clearly described below in conjunction with the embodiments and accompanying drawings of the present application. Obviously, the described embodiments are only some of the embodiments of the present application, rather than all the embodiments. All other embodiments obtained by those skilled in the art based on the present application fall within the protection scope of the present application.

It should be noted that in the detailed description of the present application, a lithium-ion battery is used as an example of a secondary battery to explain the present application, but the secondary battery of the present application is not limited to a lithium-ion battery. The specific technical solution is as follows:
A first aspect of the present application provides a negative electrode sheet including a negative electrode current collector and a negative electrode material layer. Along a length direction of the unfolded negative electrode sheet, the negative electrode sheet includes a blank foil region and a single-sided negative electrode material layer region connected to the blank foil region. Based on a length of the negative electrode sheet, a length proportion of the blank foil region is A, and a length proportion of the single-sided negative electrode material layer region is B, where 1/60≤A≤1/11, preferably 1/30≤A≤1/11; and 1/20≤B 1/5, preferably 1/14≤B≤1/5. For example, the value of A may be 1/60, 1/50, 1/40, 1/30, 1/29, 1/28, 1/27, 1/26, 1/25, 1/24, 1/23, 1/22, 1/21, 1/20, 1/19, 1/18, 1/17, 1/16, 1/15, 1/14, 1/13, 1/12, 1/11, or in a range composed of any two of these values; and the value of B may be 1/20, 1/19, 1/18, 1/17, 1/16, 1/15, 1/14, 1/13, 1/12, 1/11, 1/10, 1/9, 1/8, 1/7, 1/6, 1/5, or in a range composed of any two of these values. A plurality of grooves are provided on the negative electrode material layer in the single-sided negative electrode material layer region, and the grooves are spaced apart along the length direction of the negative electrode sheet.

In the present application, by regulating the values of A and B within the above ranges and providing the grooves on the negative electrode material layer in the single-sided negative electrode material layer region, it helps disperse the residual stress from cold pressing received by the single-sided negative electrode material layer region, mitigate the problem of stress concentration in the single-sided negative electrode material layer region, and mitigate the curling of the single-sided region negative electrode sheet when the single-sided region negative electrode sheet is applied to a secondary battery, thereby reducing the risk of strip breakage and feeding folding of the single-sided region negative electrode sheet during actual processing, increasing the winding yield of the secondary battery, and reducing the capacity loss of the secondary battery and safety risks of short circuit caused by folding. In addition, the provision of the grooves on the negative electrode material layer in the single-sided negative electrode material layer region improves the wettability of the electrolyte to the single-sided region negative electrode sheet, and enhances the electrolyte retention performance of the single-sided negative electrode material layer region, thereby enhancing the kinetic performance and safety performance of the secondary battery.

In some embodiments of the present application, along a thickness direction of the negative electrode sheet, a single groove has an orthographic projection on the negative electrode material layer; along the length direction of the negative electrode sheet, a length of the single-sided negative electrode material layer region is L mm; and the negative electrode sheet further includes a double-sided negative electrode material layer region, where the single-sided negative electrode material layer region and the double-sided negative electrode material layer region have a boundary line, a shortest distance between an outer contour of the orthographic projection of the single groove and the boundary line is L₁ mm, where 1/2≤(L-L₁)/L≤1. For example, the value of (L-L₁)/L may be 1/2, 11/20, 3/5, 13/20, 7/10, 3/4, 4/5, 19/20, 1, or in a range composed of any two of these values.

For ease of understanding, in the present application, when the negative electrode sheet is applied to an electrode assembly having a wound structure, it is defined that in the unfolded state of the electrode assembly, the length direction of the negative electrode sheet is direction X, the width direction of the negative electrode sheet is direction Y, and the thickness direction of the negative electrode sheet is direction Z. It can be understood that the length directions, width directions, and thickness directions of the negative electrode sheet, the positive electrode sheet, and the separator in the unfolded state are the same as those of the electrode assembly, and the winding direction of the electrode assembly is direction W. The above direction limitations are only for understanding the technical solution of the present application and do not limit the protection scope of the present application.

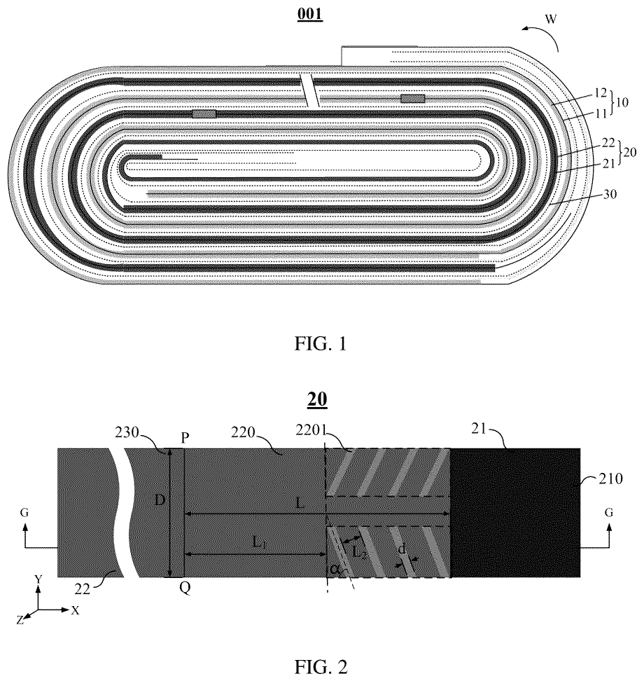

Exemplarily, as shown in FIG. 1 to FIG. 2, the electrode assembly 001 includes a positive electrode sheet 10, a negative electrode sheet 20, and a separator 30. The negative electrode sheet 20 includes a negative electrode current collector 21 and a negative electrode material layer 22. Along a length direction (direction X) of the unfolded negative electrode sheet 20 and along the winding direction (direction W) of the electrode assembly 001, the negative electrode sheet 20 includes a blank foil region 210, a single-sided negative electrode material layer region 220, and a double-sided negative electrode material layer region 230. The single-sided negative electrode material layer region 220 is close to the winding center of the electrode assembly 001, and the negative electrode material layer 22 of the single-sided negative electrode material layer region 220 is provided on a side of the negative electrode current collector 21 facing away from the winding center of the electrode assembly 001. A plurality of grooves 2201 are provided on the negative electrode material layer 22 of the single-sided negative electrode material layer region 220, and the plurality of grooves 2201 extend along a width direction (direction Y) of the unfolded negative electrode sheet 20 and are spaced apart along the length direction (direction X) of the unfolded negative electrode sheet 20. Along the length direction (direction X) of the unfolded negative electrode sheet 20 and along the winding direction (direction W) of the electrode assembly 001, a length of the single-sided negative electrode material layer region 220 is L mm, the single-sided negative electrode material layer region 220 and the double-sided negative electrode material layer region 230 have a boundary line PQ, and a shortest distance between an outer contour of an orthographic projection of a single groove 2201 and the boundary line PQ is L₁ mm.

By regulating the value of (L-L₁)/L within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

In some embodiments of the present application, along a width direction of the negative electrode sheet, the single-sided negative electrode material layer region includes a middle region and two edge regions connected to the middle region, where the grooves are distributed at intervals in the two edge regions and separately extend through the two edge regions; and based on a width of the negative electrode material layer in the single-sided negative electrode material layer region, a length proportion of the middle region is C, where 0%≤C≤30%. For example, the value of C may be 0%, 2%, 5%, 8%, 10%, 12%, 15%, 18%, 20%, 22%, 25%, 28%, 30%, or in a range composed of any two of these values. Exemplarily, as shown in FIG. 2, along the width direction (direction Y) of the unfolded negative electrode sheet 20, the single-sided negative electrode material layer region 220 includes a middle region and two edge regions connected to the middle region, where the two edge regions are portions in the dashed box in the single-sided negative electrode material layer region 220. The grooves 2201 are distributed at intervals in the two edge regions and separately extend through the two edge regions. By regulating the value of C within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

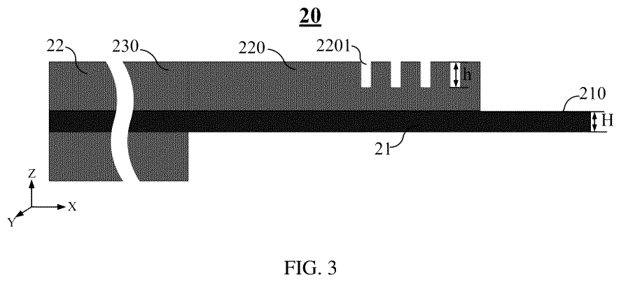

In some embodiments of the present application, the negative electrode current collector includes a copper foil, where a thickness of the copper foil is H m, where 4≤H≤8. For example, the value of H may be 4, 4.5, 5, 5.5, 6, 6.5, 7, 7.5, 8, or in a range composed of any two of these values. Exemplarily, as shown in FIG. 3, a thickness of the negative electrode current collector 21 is H km. By regulating the value of H within the above range, it helps mitigate the curling of the single-sided negative electrode material layer region while maintaining the energy density, thereby further reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery. There is no particular limitation on the manner of regulating the thickness of the negative electrode current collector in the present application, as long as the purpose of the present application can be achieved. For example, commercially available current collectors of different thicknesses may be selected, and the thickness of the negative electrode current collector may be determined in combination with the test method of “testing L, A, B, L₁, C, H, D, h, d, L₂, α, S₁/S₂” in the present application, thereby selecting a negative electrode current collector of the required thickness.

In some embodiments of the present application, a coating weight per unit area of the negative electrode material layer in the single-sided negative electrode material layer region is m mg/1540.25 mm², where 100≤m≤200. For example, the value of m may be 100, 110, 120, 130, 140, 150, 160, 170, 180, 190, 200, or in a range composed of any two of these values. By regulating the value of m within the above range, it helps mitigate the curling of the single-sided negative electrode material layer region while ensuring the energy density, thereby further reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery.

In some embodiments of the present application, the negative electrode current collector includes a copper foil, where a thickness of the copper foil is H m, where 4≤H≤8. For example, the value of H may be 4, 4.5, 5, 5.5, 6, 6.5, 7, 7.5, 8, or in a range composed of any two of these values; and a coating weight per unit area of the negative electrode material layer in the single-sided negative electrode material layer region is m mg/1540.25 mm², where 100≤m 200. For example, the value of m may be 100, 110, 120, 130, 140, 150, 160, 170, 180, 190, 200, or in a range composed of any two of these values. By regulating the values of H and m within the above ranges, it helps mitigate the curling of the single-sided negative electrode material layer region while ensuring the energy density, thereby further reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery.

In some embodiments of the present application, along a width direction of the negative electrode sheet, a width of the negative electrode sheet is D mm; and along the length direction of the negative electrode sheet, a length of the single-sided negative electrode material layer region is L mm, where 1≤L/D≤2, and 50≤D≤130. For example, the value of L/D may be 1, 1.1, 1.2, 1.3, 1.4, 1.5, 1.6, 1.7, 1.8, 1.9, 2, or in a range composed of any two of these values; and the value of D may be 50, 60, 70, 80, 90, 100, 110, 120, 130, or in a range composed of any two of these values. Exemplarily, as shown in FIG. 2, along the width direction (direction Y) of the unfolded negative electrode sheet 20, the width of the negative electrode sheet 20 is D mm; and along the length direction (direction Y) of the unfolded negative electrode sheet 20, the length of the single-sided negative electrode material layer region 220 is L mm. By regulating the values of L/D and D within the above ranges, the ratio of the length L of the single-sided negative electrode material layer region to the width D of the negative electrode sheet is larger, the constraint of the double-sided negative electrode material layer region on the single-sided negative electrode material layer region is smaller, and the amplitude of corner curling is greater. By regulating the values of L/D and D within the above ranges, it helps mitigate the curling of the single-sided negative electrode material layer region, thereby further reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery. Furthermore, the width of the negative electrode sheet and the length of the single-sided negative electrode material layer region are related to the shape of the electrode assembly formed after winding, and regulating the shape of the electrode assembly helps maintain the actual production efficiency and processing performance.

In some embodiments of the present application, the negative electrode sheet further includes a double-sided negative electrode material layer region, the negative electrode material layer includes a negative electrode active material, and the negative electrode active material includes at least one of graphite or a silicon-carbon composite material; where a compacted density of the negative electrode material layer in the single-sided negative electrode material layer region is PD₁ g/cm³, a compacted density of the negative electrode material layer in the double-sided negative electrode material layer region is PD₂ g/cm³, where 0.95≤PD₁/PD₂≤1. For example, the value of PD₁/PD₂ may be 0.95, 0.955, 0.96, 0.965, 0.97, 0.975, 0.98, 0.985, 0.99, 0.995, 1, or in a range composed of any two of these values. By selecting the above types of negative electrode active material and regulating the value of PD₁/PD₂ within the above range, while maintaining the energy density of the secondary battery, the effect of reducing deformation caused by residual stress from cold pressing in the single-sided negative electrode material layer region is more obvious. This mitigates the curling of the single-sided negative electrode material layer region, thereby further reducing the risk of strip breakage and feeding folding of the single-sided region negative electrode sheet during actual processing.

In some embodiments of the present application, 1.5≤PD₂≤1.8. For example, the value of PD₂ may be 1.5, 1.52, 1.55, 1.58, 1.6, 1.62, 1.65, 1.68, 1.7, 1.72, 1.75, 1.78, 1.8, or in a range composed of any two of these values. By regulating the value of PD₂ within the above range, while maintaining the energy density of the secondary battery, the effect of reducing deformation caused by residual stress from cold pressing in the single-sided negative electrode material layer region is more obvious. This mitigates the curling of the single-sided negative electrode material layer region, thereby further reducing the risk of strip breakage and feeding folding of the single-sided region negative electrode sheet during actual processing.

In some embodiments of the present application, along a thickness direction of the negative electrode sheet, an average depth of the plurality of grooves is h m, where 5≤h≤30. For example, the value of h may be 5, 8, 10, 12, 15, 18, 20, 22, 25, 28, 30, or in a range composed of any two of these values. Exemplarily, as shown in FIG. 3, along the thickness direction (direction Z) of the negative electrode sheet 20, the average depth of the plurality of grooves 2201 is h m. By regulating the value of h within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery. Furthermore, the actual production efficiency is maintained and processing is facilitated without the groove depth being excessively large.

In some embodiments of the present application, the plurality of grooves are distributed in a strip shape; and along the thickness direction of the negative electrode sheet, a single groove has an orthographic projection on the negative electrode material layer, and an average width of the orthographic projections of the plurality of grooves is d μm, where 50≤d≤110. For example, the value of d may be 50, 60, 70, 80, 90, 100, 110, or in a range composed of any two of these values. Exemplarily, as shown in FIG. 2, the plurality of grooves 2201 are distributed in a strip shape; and along the thickness direction (direction Z) of the negative electrode sheet 20, a single groove 2201 has an orthographic projection on the negative electrode material layer 22, and the average width of the orthographic projections of the plurality of grooves 2201 is d m. By regulating the value of d within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

In some embodiments of the present application, the plurality of grooves are distributed in a strip shape; and along the thickness direction of the negative electrode sheet, a single groove has an orthographic projection on the negative electrode material layer, and a shortest distance between the outer contours of the orthographic projections of two adjacent grooves is L₂ mm, where 0.5≤L₂≤1.5. For example, the value of L₂ may be 0.5, 0.6, 0.7, 0.8, 0.9, 1, 1.1, 1.2, 1.3, 1.4, 1.5, or in a range composed of any two of these values. Exemplarily, as shown in FIG. 2, the plurality of grooves 2201 are distributed in a strip shape; along the thickness direction (direction Z) of the negative electrode sheet 20, a single groove 2201 has an orthographic projection on the negative electrode material layer 22, and the shortest distance between the outer contours of the orthographic projections of two adjacent grooves 2201 is L₂ mm. By regulating the value of L₂ within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and facilitating processing.

In some embodiments of the present application, the plurality of grooves are distributed in a strip shape; and along the thickness direction of the negative electrode sheet, a single groove has an orthographic projection on the negative electrode material layer, the average width of the orthographic projections of the plurality of grooves is d m, where 50≤d≤110. For example, the value of d may be 50, 60, 70, 80, 90, 100, 110, or in a range composed of any two of these values; and the shortest distance between the outer contours of the orthographic projections of two adjacent grooves is L₂ mm, where 0.5≤L₂≤1.5. For example, the value of L₂ may be 0.5, 0.6, 0.7, 0.8, 0.9, 1, 1.1, 1.2, 1.3, 1.4, 1.5, or in a range composed of any two of these values. By regulating the values of L₂ and d within the above ranges, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery, while maintaining the actual production efficiency and energy density and facilitating processing, so that the pore distribution of the negative electrode sheet is uniform.

In some embodiments of the present application, an included angle between the center line of a single groove and the length direction of the negative electrode sheet is α°, where 20≤α≤75. For example, the value of α may be 20, 25, 30, 35, 40, 45, 50, 55, 60, 65, 70, 75, or in a range composed of any two of these values. Exemplarily, as shown in FIG. 2, the included angle between the center line of a single groove 2201 and the length direction (direction X) of the unfolded negative electrode sheet 20 is α°. By regulating the value of a within the above range, it helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance of the secondary battery, while maintaining the actual production efficiency and energy density and facilitating processing.

In some embodiments of the present application, the included angle between the center line of a single groove and the length direction of the negative electrode sheet is α°, where 40≤α≤50. For example, the value of a may be 40, 41, 42, 43, 44, 45, 46, 47, 48, 49, 50, or in a range composed of any two of these values. By regulating the value of a within the above range, through oblique arrangement of the grooves, stress dispersion is more obvious, which further mitigates the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance of the secondary battery, while maintaining the actual production efficiency and energy density and facilitating processing.

In some embodiments of the present application, along the thickness direction of the negative electrode sheet, a total area of the orthographic projections of the plurality of grooves is S₁ mm², a projected area of the single-sided negative electrode material layer region is S₂ mm², where 2%≤S₁/S₂≤10%. For example, the value of S₁/S₂ may be 2%, 2.2%, 2.5%, 2.8%, 3%, 3.2%, 3.5%, 3.8%, 4%, 4.2%, 4.5%, 4.8%, 5%, 5.2%, 5.5% 5.8%, 6%, 6.2%, 6.5%, 6.8%, 7%, 7.2%, 7.5% 7.8%, 8%, 8.2%, 8.5%, 8.8%, 9%, 9.2%, 9.5%, 9.8%, 10%, or in a range composed of any two of these values. Exemplarily, as shown in FIG. 2, the total area S₁ of the orthographic projections of the plurality of grooves 2201 is the sum of the areas of the orthographic projections of all grooves 2201 in the edge regions within the dashed box in the figure, and the area S₂ of the single-sided negative electrode material layer region 220 is equal to L×D. By regulating the value of S₁/S₂ within the above range, it helps enhance the overall rigidity of the single-sided material layer region, and in turn helps mitigate the curling of the single-sided negative electrode material layer region, thereby reducing the risk of strip breakage and feeding folding of the single-sided region negative electrode sheet during actual processing. In addition, it also helps improve the wettability of the electrolyte to the single-sided region negative electrode sheet, and enhance the electrolyte retention performance of the single-sided negative electrode material layer region, thereby enhancing the kinetic performance and safety performance of the secondary battery.

In the present application, the negative electrode material layer may further include a conductive agent and a binder. There is no particular limitation on the type of conductive agent in the negative electrode material layer in the present application, as long as the purpose of the present application can be achieved. For example, the conductive agent may include, but is not limited to, at least one of conductive carbon black (Super P), carbon nanotubes (CNTs), carbon fibers, flake graphite, Ketjen black, graphene, metal materials, or conductive polymers. The carbon nanotubes may include, but are not limited to, single-walled carbon nanotubes and/or multi-walled carbon nanotubes. The carbon fibers may include, but are not limited to, vapor-grown carbon fibers (VGCF) and/or nano-carbon fibers. The metal materials may include, but are not limited to, metal powder and/or metal fibers; specifically, the metal may include, but is not limited to, at least one of copper, nickel, aluminum, or silver. The conductive polymers may include, but are not limited to, at least one of polyphenylene derivatives, polyaniline, polythiophene, polyacetylene, or polypyrrole. There is no particular limitation on the type of binder in the negative electrode material layer in the present application, as long as the purpose of the present application can be achieved. For example, the binder may include, but is not limited to, at least one of polyvinylidene fluoride, vinylidene fluoride-hexafluoropropylene copolymer, polyamide, polyacrylonitrile, polyacrylate, polyacrylic acid, polyacrylate salts, polyvinylpyrrolidone, polyvinyl ether, polymethyl methacrylate, polytetrafluoroethylene, or polyhexafluoropropylene. There is no particular limitation on the mass ratio of the negative electrode active material, conductive agent, and binder in the negative electrode material layer in the present application, as long as the purpose of the present application can be achieved.

There is no particular limitation on the preparation method of the negative electrode sheet in the present application, as long as the purpose of the present application can be achieved. For example, the preparation method of the negative electrode sheet includes, but is not limited to, the following steps: (1) preparing a negative electrode slurry; (2) pre-determining a region on the negative electrode current collector where a single-sided negative electrode material layer is provided, a region where a double-sided negative electrode material layer is provided, and a region where no negative electrode material layer is provided; (3) according to the regions determined on the negative electrode current collector in step (2), applying the negative electrode slurry on one surface of the negative electrode current collector and drying to form a negative electrode sheet including a single-sided coated negative electrode material layer; (4) according to the regions determined on the negative electrode current collector in step (2), applying the slurry on the other surface of the negative electrode current collector and drying to obtain a negative electrode sheet including a double-sided coated negative electrode material layer; and (5) after cold pressing, die cutting, slitting, and other subsequent processes, grooves are provided in the single-sided negative electrode material layer region to obtain the negative electrode sheet of the present application.

In some embodiments, after step (4), a middle region and two edge regions connected to the middle region are determined in the single-sided negative electrode material layer region; and during the arrangement of grooves in the single-sided negative electrode material layer region, the grooves are provided in the two edge regions and separately extend through the two edge regions.

There is no particular limitation on the solid content of the above slurry in the present application, as long as the purpose of the present application can be achieved. There is no particular limitation on the temperature and time of the above drying in the present application, as long as the purpose of the present application can be achieved. There is no particular limitation on the process parameters of the above cold pressing, die cutting, slitting, and other subsequent processes in the present application, as long as the purpose of the present application can be achieved.

There is no particular limitation on the method of providing grooves in the present application, and those skilled in the art may select it according to actual needs, as long as the purpose of the present application can be achieved. For example, the grooves may be provided by pulsed laser etching. The value of (L-L₁)/L may be controlled by regulating the length L of the single-sided negative electrode material layer region and the speed of the pulsed laser emitter and the etching feeding web; the value of C may be regulated by adjusting the width of the negative electrode material layer in the single-sided negative electrode material layer region, the power and defocus amount of the pulsed laser emitter; the average depth h of the plurality of grooves and the average width d of the orthographic projections of the plurality of grooves may be regulated by the power and defocus amount of the pulsed laser emitter; the shortest distance L₂ between the outer contours of the orthographic projections of two adjacent grooves may be regulated by adjusting the spacing between pulsed laser emitters or the laser emission frequency; the included angle α between the center line of a single groove and the length direction of the unfolded negative electrode sheet may be regulated by adjusting the position, power, and defocus amount of the pulsed laser emitter; the ratio S₁/S₂ of the total area S₁ of the orthographic projections of the plurality of grooves to the projected area S₂ of the single-sided negative electrode material layer region may be regulated by adjusting the projected area of the single-sided negative electrode material layer region, the power and defocus amount of the pulsed laser emitter, and the number of grooves provided in the single-sided negative electrode material layer region.

In the present application, different features of providing grooves in the above single-sided negative electrode material layer region may be arbitrarily combined, and the embodiments or examples covered by the above combinations all fall within the protection scope of the present application.

A second aspect of the present application provides a secondary battery including a positive electrode sheet, a separator, and the negative electrode sheet in any one of the above embodiments. Applying the negative electrode sheet of the present application to a secondary battery mitigates the curling of the single-sided region negative electrode sheet, reduces the risk of feeding folding and strip breakage of the single-sided region negative electrode sheet during the manufacturing process, and improves the wettability of the electrolyte to the single-sided region negative electrode sheet, thereby enhancing the kinetic performance and safety performance of the secondary battery.

In some embodiments of the present application, the secondary battery has a wound structure, and the blank foil region and the single-sided negative electrode material layer region are provided at the starting end of the wound structure, which can more specifically solve the problem that the negative electrode sheet in the single-sided negative electrode material layer region at the winding starting end exhibits obvious stress concentration after cold pressing, reduce the risk of feeding folding and strip breakage of the single-sided region negative electrode sheet during the manufacturing process, and improve the wettability of the electrolyte to the single-sided region negative electrode sheet, thereby enhancing the kinetic performance and safety performance of the secondary battery.

There is no particular limitation on the separator in the present application, as long as the purpose of the present application can be achieved. For example, the material of the separator may include, but is not limited to, at least one of polyethylene (PE), polyolefin (PO)-based materials mainly including polypropylene (PP), polyester (for example, polyethylene terephthalate (PET) film), cellulose, polyimide (PI), polyamide (PA), spandex, or aramid. The type of separator may include at least one of woven film, non-woven film, microporous film, composite film, calendered film, or spun film.

In some embodiments of the present application, the separator may include a substrate layer and a surface treatment layer. The substrate layer may be a non-woven fabric, film, or composite film having a porous structure, and the material of the substrate layer may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is provided on at least one surface of the substrate layer, and the surface treatment layer may be a polymer layer or an inorganic layer, or a layer formed by mixing a polymer and an inorganic material. In some embodiments of the present application, the inorganic layer includes inorganic particles and a binder. There is no particular limitation on the inorganic particles in the present application, for example, the inorganic particles may include at least one of alumina, silicon dioxide, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. There is no particular limitation on the binder in the present application, for example, the binder may be at least one of the binders described above. In some embodiments of the present application, the polymer layer includes a polymer, and the material of the polymer includes at least one of polyamide, polyacrylonitrile, acrylate polymer, polyacrylic acid, polyacrylate salts, polyvinylpyrrolidone, polyvinyl ether, polyvinylidene fluoride, or poly(vinylidene fluoride-co-hexafluoropropylene). In the present application, there is no particular limitation on the thickness of the separator, as long as the purpose of the present application can be achieved, for example, the thickness of the separator may be 3 μm to 30 μm.

There is no particular limitation on the positive electrode sheet in the present application, as long as the purpose of the present application can be achieved. For example, the positive electrode sheet includes a positive electrode current collector and a positive electrode material layer provided on at least one surface of the positive electrode current collector. The above “positive electrode material layer provided on at least one surface of the positive electrode current collector” means that the positive electrode material layer may be provided on one surface of the positive electrode current collector along a thickness direction of the positive electrode current collector, or may be provided on two surfaces of the positive electrode current collector along a thickness direction of the positive electrode current collector. It should be noted that the “surface” here may be the entire area of the surface of the positive electrode current collector or a part of the area of the surface of the positive electrode current collector, and there is no particular limitation in the present application as long as the purpose of the present application can be achieved. Exemplarily, as shown in FIG. 1, the positive electrode material layer 12 is provided on two surfaces of the positive electrode current collector 11 along a thickness direction of the positive electrode current collector 11. There is no particular limitation on the positive electrode current collector in the present application, as long as the purpose of the present application can be achieved. For example, the positive electrode current collector may include an aluminum foil, aluminum alloy foil, composite current collector (for example, aluminum-carbon composite current collector), or the like. The positive electrode material layer of the present application includes a positive electrode active material, and there is no particular limitation on the type of positive electrode active material in the present application, as long as the purpose of the present application can be achieved. For example, the positive electrode active material may include at least one of lithium nickel cobalt manganese oxide (LiNi_{0.90}Co_{0.05}Mn_{0.05}O₂(NCM955), NCM811, NCM622, NCM523, NCM111), lithium nickel cobalt aluminate, lithium iron phosphate, lithium-rich manganese-based material, lithium cobalt oxide (LiCoO₂), lithium manganate, lithium iron manganese phosphate, or lithium titanate. In the present application, the positive electrode active material may further include non-metallic elements, for example, the non-metallic elements include at least one of fluorine, phosphorus, boron, chlorine, silicon, or sulfur. In the present application, there is no particular limitation on the thickness of the positive electrode current collector and the positive electrode material layer, as long as the purpose of the present application can be achieved. In the present application, the positive electrode material layer may further include a positive electrode binder and a conductive agent. There is no particular limitation on the type of positive electrode binder in the positive electrode material layer in the present application, as long as the purpose of the present application can be achieved, for example, the positive electrode binder may be of the same type as the binder in the above negative electrode material layer. There is no particular limitation on the type of conductive agent in the positive electrode material layer in the present application, as long as the purpose of the present application can be achieved, for example, the conductive agent may be the same type as the conductive agent in the above negative electrode material layer. There is no particular limitation on the mass ratio of the positive electrode active material, conductive agent, and binder in the positive electrode material layer in the present application, and those skilled in the art may select it according to actual needs, as long as the purpose of the present application can be achieved.

In the present application, the secondary battery further includes an electrolyte, and the electrolyte includes a lithium salt and a non-aqueous solvent. There is no particular limitation on the lithium salt in the present application, as long as the purpose of the present application can be achieved. For example, the lithium salt may include, but is not limited to, at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato)borate (LiBOB), or lithium difluoroborate. There is no particular limitation on the content of the lithium salt in the electrolyte in the present application, as long as the purpose of the present application can be achieved. There is no particular limitation on the non-aqueous solvent in the present application, as long as the purpose of the present application can be achieved, for example, the non-aqueous solvent may include, but is not limited to, at least one of carbonate compounds, carboxylate compounds, ether compounds, or other organic solvents. The carbonate compounds may include, but are not limited to, at least one of chain carbonate compounds, cyclic carbonate compounds, or fluorinated carbonate compounds. The chain carbonate compounds may include, but are not limited to, at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonates may include, but are not limited to, at least one of ethylene carbonate (EC), propylene carbonate (PC), butylene carbonate (BC), or vinyl ethylene carbonate (VEC). The fluorinated carbonate compounds may include, but are not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compounds may include, but are not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compounds may include, but are not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. There is no particular limitation on the content of the non-aqueous solvent in the electrolyte in the present application, as long as the purpose of the present application can be achieved.

The secondary battery further includes a casing for accommodating the positive electrode sheet, the separator, the negative electrode sheet, the electrolyte, and other components known in the field of secondary batteries, and there is no limitation on the above other components in the present application. There is no particular limitation on the casing in the present application, which may be a casing known in the art, as long as the purpose of the present application can be achieved. For example, the casing may be a hard shell casing or a flexible casing. The material of the hard shell casing may be metal, and there is no limitation on the type of metal in the present application, and a metal hard shell casing known in the art may be used, as long as the purpose of the present application can be achieved. The flexible casing may be a metal-plastic film, for example, an aluminum-plastic film or a steel-plastic film.

The preparation process of the secondary battery of the present application is well known to those skilled in the art, and there is no particular limitation in the present application. For example, the preparation process of the secondary battery may include, but is not limited to, the following steps: stacking the positive electrode sheet, separator, and negative electrode sheet in sequence, and performing operations such as winding or folding them as needed to obtain an electrode assembly with a wound structure, placing the electrode assembly into a casing, injecting the electrolyte into the casing, and sealing to obtain a secondary battery. Alternatively, stacking the positive electrode sheet, separator, and negative electrode sheet in sequence, and then fixing the four corners of the entire laminated structure with tape to obtain an electrode assembly having a laminated structure, placing the electrode assembly into a casing, injecting the electrolyte into the casing, and sealing to obtain a secondary battery. In addition, as needed, overcurrent prevention elements, guide plates, and the like may be placed in the casing to prevent pressure rise, overcharge, and overdischarge inside the secondary battery.

A third aspect of the present application provides an electronic device including the secondary battery according to any one of the above embodiments, so that the electronic device provided by the present application has good performance.

There is no particular limitation on the electronic device of the present application, which may be any electronic device known in the prior art. For example, the electronic device may include, but is not limited to, notebook computers, pen-input computers, laptop computers, e-book players, portable phones, portable fax machines, portable copiers, portable printers, stereo headphones, video recorders, liquid crystal display televisions, portable cleaners, portable CD players, mini discs, transceivers, electronic organizers, calculators, memory cards, portable recorders, radios, backup power supplies, motors, automobiles, motorcycles, power-assisted bicycles, bicycles, lighting fixtures, toys, game consoles, clocks, power tools, flashlights, cameras, large household batteries, and lithium-ion capacitors.

### EXAMPLES

The embodiments of the present application will be more specifically described below with examples and comparative examples. Various tests and evaluations were carried out according to the following methods. In addition, unless otherwise specified, “parts” and “%” are on a mass basis.

Test methods and equipment:

Testing of L, A, B, L₁, C, H, D, h, d, L₂, α, S₁/S₂:

At an ambient temperature of 25° C., the lithium-ion batteries of various examples and comparative examples were discharged to 2.5 V at 0.5C and then disassembled to obtain electrode assemblies. The negative electrode sheets were respectively taken out from the electrode assemblies, soaked in dimethyl carbonate (DMC) for 20 min, and then placed in an oven and dried at 80° C. for 12 h to obtain test samples of the negative electrode sheets.

The negative electrode sheet was unfolded, and along the length direction of the unfolded negative electrode sheet, the blank foil region, single-sided negative electrode material layer region, and double-sided negative electrode material layer region of the negative electrode sheet were determined by visual observation, and the length L of the single-sided negative electrode material layer region, the length of the blank foil region, and the length of the negative electrode sheet were separately measured with a tape measure. Thereafter, based on the length of the negative electrode sheet, the length proportion A of the blank foil region and the length proportion B of the single-sided negative electrode material layer region were calculated. The plane where the length direction and width direction of the unfolded negative electrode sheet are located was observed to determine the boundary line between the single-sided negative electrode material layer region and the double-sided negative electrode material layer region; along the length direction of the unfolded negative electrode sheet, the shortest distance L₁ between the outer contour of a single groove on the surface of the negative electrode sheet and the boundary line was measured, and the value of (L-L₁)/L was calculated. The plane where the length direction and width direction of the unfolded negative electrode sheet are located was observed; along the width direction of the unfolded negative electrode sheet, the arrangement position of the grooves was observed; if the grooves extended through the width direction of the unfolded negative electrode sheet, the proportion of the middle region of the single-sided negative electrode material layer region was 0, and based on the width of the negative electrode material layer in the single-sided negative electrode material layer region, the length proportion C of the middle region was 0; if the grooves did not extend through the width direction of the unfolded negative electrode sheet, the length of the non-groove portion in the single-sided negative electrode material layer region and the width of the negative electrode material layer in the single-sided negative electrode material layer region were measured along the width direction of the unfolded negative electrode sheet, and the length proportion C of the middle region=the length of the portion of the non-groove portion in the single-sided negative electrode material layer region/the width of the negative electrode material layer in the single-sided negative electrode material layer region.

Each groove in the single-sided negative electrode material layer region was photographed using a scanning electron microscope, and the projected area of a single groove was calculated using image recognition and then summed to obtain the total area S₁ of the orthographic projections of the plurality of grooves; the measured length L of the single-sided negative electrode material layer region was multiplied by the measured width of the single-sided negative electrode material layer region to obtain the projected area S₂ of the single-sided negative electrode material layer region, and then S₁/S₂ was calculated.

Five grooves located in the single-sided negative electrode material layer region were randomly selected. Five positions were arbitrarily chosen on a single groove, and the width of the groove at these five positions was measured. The average value of these measurements was taken as the width of the orthographic projection of the single groove on the negative electrode material layer. The average of the widths of the five selected grooves was then calculated to obtain the average width d of the orthographic projections of the plurality of grooves on the negative electrode material layer. The shortest distance between the outer contour of a single groove on the negative electrode material layer and the outer contour of an adjacent groove on the negative electrode material layer was measured, which was defined as the shortest distance L₂ between the outer contours of the orthographic projections of two adjacent grooves. Another five grooves were randomly selected, and the center line of each individual groove was identified. The included angle between the center line of each individual groove and the length direction of the unfolded negative electrode sheet was measured respectively, and the average value of these included angles was taken as the included angle α between the center line of a single groove and the length direction of the unfolded negative electrode sheet.

Along the thickness direction and the unfolded length direction of the negative electrode sheet, the negative electrode sheet was cut to obtain a longitudinal section of the negative electrode sheet. Ion polishing was performed on this longitudinal section of the negative electrode sheet, and observation was conducted using a scanning electron microscope, which enabled clear visualization of the boundary between the negative electrode material layer and the negative electrode current collector. Along the thickness direction of the negative electrode sheet, the thickness H of the negative electrode current collector was measured with a micrometer. Five grooves were randomly selected, and still along the thickness direction of the negative electrode sheet, the distance from the surface of the negative electrode material layer to the bottom surface of each single groove was measured using the micrometer. The average value of these distances was taken as the average depth h of the plurality of grooves.

Testing of coating weight per unit area of negative electrode material layer:
At an ambient temperature of 25° C., the lithium-ion battery was disassembled to obtain an electrode assembly with a wound structure. The negative electrode sheet was taken out to be soaked in dimethyl carbonate (DMC) for 20 min, then the negative electrode sheet was placed in an oven and dried at 80° C. for 12 h to obtain a test sample of the negative electrode sheet. The blank foil region, the single-sided negative electrode material layer region, and the double-sided negative electrode material layer region of the negative electrode sheet were determined.

The negative electrode sheet sample in the single-sided negative electrode material layer region was punched into two small discs with a radius of 22.14 mm (area of 1540.25 mm²), these small discs were weighed sequentially and the average value was calculated and recorded as a; the negative electrode material layer on the small discs was wiped off with deionized water, and these small discs were weighed sequentially and the average value was calculated and recorded as a₁. The negative electrode sheet sample in the double-sided negative electrode material layer region was punched into four small discs with a radius of 22.14 mm (area of 1540.25 mm²), these small discs were weighed sequentially and the average value was calculated and recorded as b; the negative electrode material layers on both surfaces of the small discs were wiped off with deionized water, and these small discs were weighed sequentially and the average value was calculated and recorded as b₁. Then,
the coating weight per unit area of the negative electrode material layer in the single-sided negative electrode material layer region M=a−a₁; and
the coating weight per unit area of the negative electrode material layer in the double-sided negative electrode material layer region=(b−b₁)/2.

Testing of PD₁ and PD₂:
Refer to “Testing of coating weight per unit area of the negative electrode material layer” to obtain the coating weight per unit area of the negative electrode material layer in the single-sided negative electrode material layer region and the coating weight per unit area of the negative electrode material layer in the double-sided negative electrode material layer region. Refer to the testing steps of “Testing of L, A, B, L₁, C, H, D, h, d, L₂, α, S₁/S₂” and measure the thickness of the single-sided negative electrode material layer using a micrometer. Then PD₁ and PD₂ were calculated according to the following formulas:
compacted density PD₁ of the negative electrode material layer in the single-sided negative electrode material layer region=coating weight per unit area of the negative electrode material layer in the single-sided negative electrode material layer region/thickness of the single-sided negative electrode material layer; and
compacted density PD₂ of the negative electrode material layer in the double-sided negative electrode material layer region=coating weight per unit area of the negative electrode material layer in the double-sided negative electrode material layer region/thickness of the single-sided negative electrode material layer.

Low-temperature kinetic rate 0° C. lithium plating test for the innermost single-sided negative electrode material layer region:
The lithium-ion battery was placed in an environment of 0° C., charged at constant current with rates of 0.5C, 0.7C, 1.0C, 1.2C, 1.5C, 1.7C, 2.0C, 2.2C, 2.4C, 2.6C, 2.8C, 3.0C, 3.2C, 3.4C, 3.6C, 3.8C, 4.0C, 4.2C, 4.4C, 4.6C, 4.8C, and 5.0C to a voltage of 4.5 V, then charged constant voltage of 4.5 V to a cut-off current of 0.05C, left standing for 5 min, discharged at a constant current of 0.5C to a voltage of 3.0 V, and left standing for 5 min. This constituted one charge-discharge cycle. Then 10 cycles of charging and discharging were repeated with the same steps.

Next, the lithium-ion battery was charged at a constant current with the same rates to 4.5 V, then charged at constant voltage of 4.5 V to a cut-off current of 0.05C, and left standing for 5 min. The lithium-ion battery was disassembled to inspect the interface of the single-sided negative electrode material layer region. Disassembly and inspection were performed incrementally from low rate to high rate until slight plating of white metallic lithium was observed. The corresponding rate was recorded as the maximum rate of low-temperature kinetics in the single-sided negative electrode material layer region. For example, if slight lithium plating was observed on the single-sided negative electrode during disassembly at 1.5C, the low-temperature kinetic rate was recorded as 1.5C.

Energy density test:
(1) The lithium-ion battery was placed in an environment of 25° C., charged at a constant current of 1C to a voltage of 4.5 V, then charged at constant voltage of 4.5 V to a cut-off current of 0.05C, left standing for 5 min, discharged at a constant current of 0.2C to a voltage of 3.0 V, and left standing for 5 min. The discharge capacity at this time was recorded as C.
(2) The actual thickness Da, Db, Dc of the electrode assembly at 3 mm near the edge of the head, 3 mm near the edge of the tail, and the middle region were measured using a micrometer, with 3 groups of data each. For example, the first data of the head was recorded as Dai, and so on. Then the average thickness D was calculated as follows:

$$D = ( 1 / 3 \times ( {Da}_{1} + {Da}_{2} + {Da}_{3} ) + 1 / 3 \times ( {Db}_{1} + {Db}_{2} + {Db}_{3} ) + 1 / 3 \times ( {Dc}_{1} + {Dc}_{2} + {Dc}_{3} ) ) / 3$$

(3) Then a laser measuring instrument was used to scan and measure the length L and width M of the lithium-ion battery.
(4) Then the actual energy density X of the lithium-ion battery was calculated using the formula: X=C/(D×L×M).
(5) The energy density X₀ of Comparative Example 1 was set as the “low” level standard, and each increase of 0.2% was one gradient of energy density. with the ranking as follows: high>medium-high>medium>medium-low>low. The energy density in Comparative Example 1 was 654.1 Wh/L.

Winding yield test related to feeding folding/single-sided negative electrode material layer region strip breakage:
(1) Several rolls of negative electrode sheets prepared in each Example and Comparative Example were taken, totaling N strips (N=1000).
(2) A sufficient quantity of separators and positive electrode sheets corresponding to the negative electrode sheets prepared in each Example and Comparative Example in Step (1) was taken, with the quantity being far greater than N.
(3) The negative electrode sheets, separators, and positive electrode sheets from Steps (1) and (2) were used for assembly production in accordance with the winding method of the lithium-ion batteries described in each Example and Comparative Example.
(4) The total scrap quantity M of negative electrode sheets caused by feeding folding or strip breakage in the single-sided region during the winding process was recorded.
(5) Winding yield (%) of the negative electrode sheet=(1−M/N)×100%.

500-cycle interface characteristics of the single-sided region:

The lithium-ion batteries prepared in the Examples and Comparative Examples were placed in a 25° C. constant-temperature test chamber and left standing for 30 min to reach a constant temperature. Each battery was charged at a constant current of 0.5C to 4.5 V, then charged at a constant voltage of 4.5 V until the current dropped to 0.025C, and left standing for 5 min. It was then discharged at a constant current of 0.5C to 3.0 V, and the discharge capacity at this point was recorded as the initial discharge capacity C₀. The above steps were repeated for 500-cycles, and the discharge capacity after 500-cycles was recorded as C₁. The 500-cycle capacity retention rate of the lithium-ion battery was calculated using the formula: cycle capacity retention rate (%)=(C₁/C₀)×100%. Meanwhile, the cycled lithium-ion batteries were fully charged (charged at a constant current of 0.5C to 4.5 V) and then disassembled for analysis to examine the interface condition of the single-sided negative electrode material layer region after 500-cycles and identify differences.

The electrochemical performance of the lithium-ion batteries was characterized by the cycle capacity retention rate and the interface condition of the single-sided negative electrode region. Specifically, a normal interface condition and a higher capacity retention rate indicate better electrochemical performance of the lithium-ion battery; an abnormal interface condition and a lower capacity retention rate indicate poorer electrochemical performance of the lithium-ion batteries. Herein, “interface condition” refers to the surface condition of the negative electrode sheet after the lithium-ion battery is disassembled in a fully charged state following cycling; “normal interface condition” means the surface of the negative electrode sheet is free of black spots, lithium plating, purple spots, or other such phenomena; “abnormal interface condition” means the surface of the negative electrode sheet exhibits at least one of the following phenomena: black spots, lithium plating, or purple spots.

### Example 1-1

### Preparation of Negative Electrode Sheet

Artificial graphite, styrene-butadiene rubber, and sodium carboxymethylcellulose were mixed at a mass ratio of 96:2:2. Deionized water was added as the solvent, and the mixture was stirred uniformly to obtain a negative electrode slurry with a solid content of 40 wt %. The negative electrode slurry was evenly applied on one surface of a negative electrode current collector copper foil with a thickness H of 6 μm, following an intermittent coating pattern on the copper foil according to the dimensions of the electrode assembly. The coated copper foil was then dried at 85° C. to obtain a negative electrode sheet with a single-sided coated negative active material layer having a thickness of 100 m. The above coating and drying steps were repeated on the other surface of the copper foil to produce a negative electrode sheet with double-sided coated negative active material layers. After cold pressing (cold pressing pressure: 80 T), the negative electrode sheet was obtained. The sheet was cut into a fixed size, and two edge regions within the single-sided negative electrode material layer region pre-designated for groove formation were identified. Based on the width of the negative active material layer in the single-sided negative electrode material layer region, the length ratio C of non-groove portion in the middle region of the single-sided negative electrode material layer region was 15%. The orthographic projection of a single groove along the thickness direction of the negative electrode sheet was rectangular. Finally, the sheet was vacuum-dried at 120° C. for 12 h to obtain a negative electrode sheet with dimensions of 78 mm×875 mm (that is, the width D of the negative electrode sheet was 78 mm) for subsequent use. Among the key parameters: the coating weight m per unit area of the negative active material layer in the single-sided region was 150 mg/1540.25 mm²; the coating weight per unit area of the negative active material layer in the double-sided negative electrode material layer region was 150 mg/1540.25 mm²; the compacted density PD₁ of the negative active material layer in the single-sided region was 1.70 g/cm³; the compacted density PD₂ of the negative active material layer in the double-sided negative electrode material layer region was 1.73 g/cm³; based on the length of the negative electrode sheet, the length ratio A of the blank foil region was 1/20, the length ratio B of the single-sided negative electrode material layer region was 1/10, and the length L of the single-sided region was 87.5 mm.

Grooves were formed in the two edge regions of the single-sided negative electrode material layer region of the negative electrode sheet via pulsed laser etching, with specific parameters provided in Table 1. The shortest distance L₁ between the outer contour of the orthographic projection of a single groove and the boundary line was 17.5 mm. Along the thickness direction of the negative electrode sheet, the average depth h of the plurality of grooves was 20 m, the average width d of the orthographic projections of the plurality of grooves was 80 m, the shortest distance L₂ between the outer contours of the orthographic projections of two adjacent grooves was 1 mm, the included angle α between the center line of a single groove and the length direction of the unfolded negative electrode sheet was 45°, and the ratio S₁/S₂ of the total area of the orthographic projections of the plurality of grooves to the projected area of the single-sided negative electrode material layer region was 5.04%.

### Preparation of Positive Electrode Sheet

A conductive agent (conductive carbon black) and a binder (polyvinylidene fluoride) were mixed in a certain ratio, N-methylpyrrolidone (NMP) was added to prepare a conductive adhesive liquid with a solid content of 7 wt %. After the mixture became homogeneous, lithium cobalt oxide was added, stirring was continued under vacuum stirring until the system was uniform, resulting in a positive electrode slurry with a solid content of 75 wt %. Among them, lithium cobalt oxide: conductive agent: binder (mass ratio)=97:1:2. The positive electrode slurry was evenly applied on one surface of an aluminum foil with a thickness of 8 m, following an intermittent coating pattern according to the cell dimensions. The coated aluminum foil was then dried at 85° C. to obtain a positive electrode sheet with a single-sided coated positive electrode material layer having a coating thickness of 100 m. After cold pressing (cold pressing pressure of 85 T), a compacted positive electrode plate was obtained. The positive electrode sheet was cut into a fixed size, then vacuum dried at 85° C. for 4 h to obtain a positive electrode sheet with specifications of 74 mm×867 mm for standby. Among them, the coating weight per unit area of the positive electrode material layer as 300 mg/1540.25 mm², and the compacted density of the positive electrode material layer was 4.20 g/cm³.

### Preparation of Electrolyte

In a dry argon environment, non-aqueous solvents ethylene carbonate (EC), propylene carbonate (PC), and diethyl carbonate (DEC) were mixed in a weight ratio of 1:1:1, then lithium salt LiPF₆ was added to the non-aqueous solvent, and the mixture was stirred uniformly to obtain an electrolyte. Among them, the molar concentration of lithium salt LiPF₆ was 1.15 mol/L.

### Preparation of Separator

A porous polyethylene film with a thickness of 7 m (provided by Celgard) was used as the separator.

### Preparation of Lithium-Ion Battery

The positive electrode sheet, the separator, and the negative electrode sheet were stacked in sequence, with the separator between the positive electrode sheet and the negative electrode sheet for isolation, and then the stack was wound to obtain an electrode assembly. The electrode assembly was placed in an outer packaging foil, and moisture was removed at 80° C. The prepared electrolyte was injected, followed by processes such as vacuum packaging, standing, formation, shaping, and capacity testing to obtain a soft-pack lithium-ion battery.

### Examples 1-2 to 1-28

Except for adjusting relevant preparation parameters according to Table 1, the rest are the same as Example 1-1.

### Examples 2-1 to 2-11

Except for adjusting relevant preparation parameters according to Table 2, the rest are the same as Example 1-1.

### Comparative Example 1

Except that no grooves are provided on the single-sided negative electrode material layer region in <Preparation of negative electrode sheet>, the rest are the same as Example 1-1.

### Comparative Examples 2 to 6

Except for adjusting relevant preparation parameters according to Table 1, the rest are the same as Example 1-1.

The preparation parameters and performance parameters of examples and comparative examples are shown in Table 1 and Table 2.

TABLE 1

| | | | | | | | | | | | | | | Winding yield related to | |
|---|---|---|---|---|---|---|---|---|---|---|---|---|---|---|---|
| | | | | | | | | | | | | | Maximum rate of low-temper- | feeding folding/single- | 500-cycle capacity retention |
| | | | | | | | | | | | | | ature kinetics in single- | sided negative electrode | rate and interface characteristics |
| | | | | (L − | | | | | | | | S₁/ | sided negative electrode | material layer region | of single-sided negative |
| | A | B | L (mm) | L₁)/L | C (%) | D (mm) | L/D | h (μm) | d (μm) | L₂ (mm) | α (°) | S₂ (%) | material layer region (° C.) | strip breakage (%) | electrode material layer region |
| Example 1-1 | 1/20 | 1/10 | 87.5 | 4/5 | 15 | 78 | 1.122 | 20 | 80 | 1 | 45 | 5.04 | 3 | 98 | 88.5%, no |
| | | | | | | | | | | | | | | | abnormality in |
| | | | | | | | | | | | | | | | interface |
| Example 1-2 | 1/60 | 1/20 | 62.5 | 4/5 | 15 | 62.5 | 1.000 | 20 | 80 | 1 | 45 | 5.04 | 2.2 | 90 | 79.5%, no |
| | | | | | | | | | | | | | | | abnormality in |
| | | | | | | | | | | | | | | | interface |
| Example 1-3 | 1/35 | 1/17 | 87.5 | 4/5 | 15 | 70 | 1.250 | 20 | 80 | 1 | 45 | 5.04 | 2.5 | 90.5 | 80.5%, no |
| | | | | | | | | | | | | | | | abnormality in |
| | | | | | | | | | | | | | | | interface |
| Example 1-4 | 1/30 | 1/14 | 87.5 | 4/5 | 15 | 80 | 1.094 | 20 | 80 | 1 | 45 | 5.04 | 2.7 | 92.5 | 82.5%, no |
| | | | | | | | | | | | | | | | abnormality in |
| | | | | | | | | | | | | | | | interface |
| Example 1-5 | 1/11 | 1/5 | 175 | 4/5 | 15 | 87.5 | 2.000 | 20 | 80 | 1 | 45 | 5.04 | 2.5 | 92 | 83.5%, no |
| | | | | | | | | | | | | | | | abnormality in |
| | | | | | | | | | | | | | | | interface |
| Example 1-6 | 1/20 | 1/10 | 87.5 | 1/2 | 30 | 78 | 1.122 | 20 | 80 | 1 | 45 | 2.59 | 2.0 | 90 | 80.5%, no |
| | | | | | | | | | | | | | | | abnormality in |
| | | | | | | | | | | | | | | | interface |
| Example 1-7 | 1/20 | 1/10 | 87.5 | 1 | 0 | 78 | 1.122 | 20 | 80 | 1 | 45 | 7.41 | 4.5 | 99 | 89.5%, no |
| | | | | | | | | | | | | | | | abnormality in |
| | | | | | | | | | | | | | | | interface |
| Example 1-8 | 1/20 | 1/10 | 87.5 | 4/5 | 15 | 50 | 1.750 | 20 | 80 | 1 | 45 | 5.04 | 4.3 | 97 | 87.5%, no |
| | | | | | | | | | | | | | | | abnormality in |
| | | | | | | | | | | | | | | | interface |
| Example 1-9 | 1/20 | 1/10 | 135 | 4/5 | 15 | 130 | 1.038 | 20 | 80 | 1 | 45 | 5.04 | 2.0 | 90 | 80.5%, no |
| | | | | | | | | | | | | | | | abnormality in |
| | | | | | | | | | | | | | | | interface |
| Example 1-10 | 1/20 | 1/10 | 87.5 | 4/5 | 15 | 78 | 1.122 | 5 | 80 | 1 | 45 | 5.04 | 2.5 | 90 | 84.5%, no |
| | | | | | | | | | | | | | | | abnormality in |
| | | | | | | | | | | | | | | | interface |
| Example 1-11 | 1/20 | 1/10 | 87.5 | 4/5 | 15 | 78 | 1.122 | 30 | 80 | 1 | 45 | 5.04 | 4.7 | 99 | 89.5%, no |
| | | | | | | | | | | | | | | | abnormality in |
| | | | | | | | | | | | | | | | interface |
| Example 1-12 | 1/20 | 1/10 | 87.5 | 4/5 | 15 | 78 | 1.122 | 20 | 50 | 1 | 45 | 3.24 | 2.5 | 96 | 86.5%, no |
| | | | | | | | | | | | | | | | abnormality in |
| | | | | | | | | | | | | | | | interface |
| Example 1-13 | 1/20 | 1/10 | 87.5 | 4/5 | 15 | 78 | 1.122 | 20 | 110 | 1 | 45 | 6.74 | 3.7 | 97 | 87.5%, no |
| | | | | | | | | | | | | | | | abnormality in |
| | | | | | | | | | | | | | | | interface |
| Example 1-14 | 1/20 | 1/10 | 87.5 | 4/5 | 15 | 78 | 1.122 | 20 | 80 | 0.5 | 45 | 9.38 | 4.7 | 97 | 87.5%, no |
| | | | | | | | | | | | | | | | abnormality in |
| | | | | | | | | | | | | | | | interface |
| Example 1-15 | 1/20 | 1/10 | 87.5 | 4/5 | 15 | 78 | 1.122 | 20 | 80 | 1.5 | 45 | 3.44 | 2.0 | 90 | 80.5%, no |
| | | | | | | | | | | | | | | | abnormality in |
| | | | | | | | | | | | | | | | interface |
| Example 1-16 | 1/20 | 1/10 | 87.5 | 4/5 | 15 | 78 | 1.122 | 20 | 80 | 1 | 20 | 5.04 | 3 | 90 | 80.5%, no |
| | | | | | | | | | | | | | | | abnormality in |
| | | | | | | | | | | | | | | | interface |
| Example 1-17 | 1/20 | 1/10 | 87.5 | 4/5 | 15 | 78 | 1.122 | 20 | 80 | 1 | 75 | 5.04 | 3 | 90 | 80.5%, no |
| | | | | | | | | | | | | | | | abnormality in |
| | | | | | | | | | | | | | | | interface |
| Example 1-18 | 1/20 | 1/10 | 87.5 | 4/5 | 35 | 50 | 1.122 | 20 | 80 | 1 | 45 | 3.85 | 1.8 | 88 | 80%, no |
| | | | | | | | | | | | | | | | abnormality in |
| | | | | | | | | | | | | | | | interface |
| Example 1-19 | 1/20 | 1/10 | 87.5 | 4/5 | 15 | 78 | 1.122 | 32 | 80 | 1 | 45 | 5.04 | 3.0 | 80 | 83.5%, no |
| | | | | | | | | | | | | | | | abnormality in |
| | | | | | | | | | | | | | | | interface |
| Example 1-20 | 1/20 | 1/10 | 87.5 | 4/5 | 15 | 78 | 1.122 | 4 | 80 | 1 | 45 | 5.04 | 1.7 | 87 | 79.5%, no |
| | | | | | | | | | | | | | | | abnormality in |
| | | | | | | | | | | | | | | | interface |
| Example 1-21 | 1/20 | 1/10 | 87.5 | 4/5 | 15 | 78 | 1.122 | 20 | 45 | 1 | 45 | 2.93 | 2.3 | 89 | 80.5%, no |
| | | | | | | | | | | | | | | | abnormality in |
| | | | | | | | | | | | | | | | interface |
| Example 1-22 | 1/20 | 1/10 | 87.5 | 4/5 | 15 | 78 | 1.122 | 20 | 115 | 1 | 45 | 7.01 | 4 | 95.5 | 78.9%, lithium |
| | | | | | | | | | | | | | | | plating in |
| | | | | | | | | | | | | | | | interface |
| Example 1-23 | 1/20 | 1/10 | 87.5 | 4/5 | 15 | 78 | 1.122 | 20 | 80 | 0.4 | 45 | 11.33 | 4.7 | 92 | 79.6%, lithium |
| | | | | | | | | | | | | | | | plating in |
| | | | | | | | | | | | | | | | interface |
| Example 1-24 | 1/20 | 1/10 | 87.5 | 4/5 | 15 | 78 | 1.122 | 20 | 80 | 1.8 | 45 | 2.89 | 1.7 | 89 | 79.5%, no |
| | | | | | | | | | | | | | | | abnormality in |
| | | | | | | | | | | | | | | | interface |
| Example 1-25 | 1/20 | 1/10 | 87.5 | 4/5 | 15 | 78 | 1.122 | 20 | 80 | 1 | 80 | 5.04 | 2.7 | 88 | 79.8%, no |
| | | | | | | | | | | | | | | | abnormality in |
| | | | | | | | | | | | | | | | interface |
| Example 1-26 | 1/20 | 1/10 | 87.5 | 4/5 | 15 | 78 | 1.122 | 20 | 80 | 1 | 15 | 5.04 | 2.7 | 89 | 80.1%, no |
| | | | | | | | | | | | | | | | abnormality in |
| | | | | | | | | | | | | | | | interface |
| Example 1-27 | 1/20 | 1/10 | 87.5 | 4/5 | 80 | 78 | 1.122 | 20 | 80 | 1 | 45 | 1.19 | 1.7 | 87 | 79.1%, no |
| | | | | | | | | | | | | | | | abnormality in |
| | | | | | | | | | | | | | | | interface |
| Example 1-28 | 1/20 | 1/10 | 87.5 | 8/9 | 12 | 78 | 1.122 | 20 | 90 | 0.5 | 45 | 11.93 | 4.7 | 87 | 77.6%, lithium |
| | | | | | | | | | | | | | | | plating in |
| | | | | | | | | | | | | | | | interface |
| Comparative | 1/20 | 1/10 | 87.5 | / | / | 78 | 1.122 | / | / | / | / | / | 1.2 | 79 | 70.5%, lithium |
| Example 1 | | | | | | | | | | | | | | | plating and purple |
| | | | | | | | | | | | | | | | spots in interface |
| Comparative | 1/65 | 1/10 | 87.5 | 4/5 | 15 | 90 | 0.972 | 20 | 80 | 1 | 75 | 5.04 | 1.7 | 81.5 | 75.5%, lithium |
| Example 2 | | | | | | | | | | | | | | | plating and purple |
| | | | | | | | | | | | | | | | spots in interface |
| Comparative | 1/10 | 1/10 | 87.5 | 4/5 | 15 | 90 | 0.972 | 20 | 80 | 1 | 75 | 5.04 | 1.5 | 80.5 | 75%, lithium |
| Example 3 | | | | | | | | | | | | | | | plating and purple |
| | | | | | | | | | | | | | | | spots in interface |
| Comparative | 1/20 | 1/22 | 87.5 | 4/5 | 15 | 90 | 0.972 | 20 | 80 | 1 | 75 | 5.04 | 1.2 | 80.5 | 74.5%, lithium |
| Example 4 | | | | | | | | | | | | | | | plating and purple |
| | | | | | | | | | | | | | | | spots in interface |
| Comparative | 1/20 | 1/4 | 87.5 | 4/5 | 15 | 90 | 0.972 | 20 | 80 | 1 | 75 | 5.04 | 1.5 | 79 | 74%, lithium |
| Example 5 | | | | | | | | | | | | | | | plating and purple |
| | | | | | | | | | | | | | | | spots in interface |
| Comparative | 1/65 | 1/22 | 87.5 | 4/5 | 15 | 90 | 0.972 | 20 | 80 | 1 | 75 | 5.04 | 1.2 | 79 | 73%, lithium |
| Example 6 | | | | | | | | | | | | | | | plating and purple |
| | | | | | | | | | | | | | | | spots in interface |

Note:
“/” in Table 1 indicates no relevant preparation parameters.

From Examples 1-1 to 1-28 and Comparative Examples 1 to 6, it can be seen that by regulating the values of A and B within the above ranges and providing a plurality of grooves on the negative electrode material layer in the single-sided negative electrode material layer region, the maximum rate of low-temperature kinetics in the single-sided negative electrode material layer region of the lithium-ion battery is higher, the winding yield related to feeding folding/single-sided negative electrode material layer region strip breakage is increased, the 500-cycle capacity retention rate is higher, and the interface characteristics of the single-sided negative electrode material layer region are improved. These improvements indicate that the curling of the single-sided region negative electrode sheet is mitigated, thereby reducing the risk of strip breakage and feeding folding of the single-sided region negative electrode sheet during actual processing. Consequently, the winding yield of the secondary battery is increased and while maintaining the energy density of the lithium-ion battery, the lithium-ion battery has good kinetic performance and safety performance. In Comparative Example 1, no grooves are provided on the negative electrode material layer in the single-sided negative electrode material layer region. In Comparative Examples 2 to 6, the values of A and/or B are not within the range of the present application, the maximum rate of low-temperature kinetics in the single-sided negative electrode material layer region of the lithium-ion battery is lower, the winding yield related to feeding folding/single-sided negative electrode material layer region strip breakage is lower, the 500-cycle capacity retention rate is lower, and the interface characteristics of the single-sided negative electrode material layer region are poor. While the maximum rate of low-temperature kinetics in the single-sided negative electrode material layer region of the lithium-ion batteries in Examples 1-1 to 1-28 is higher, the winding yield related to feeding folding/single-sided negative electrode material layer region strip breakage is increased, the 500-cycle capacity retention rate is higher, and the interface characteristics of the single-sided negative electrode material layer region are improved, the lithium-ion battery has good safety performance and kinetic performance.

The value of (L-L₁)/L usually impairs the safety performance and kinetic performance of the lithium-ion battery. From Examples 1-1, 1-6, and 1-7, it can be seen that when the value of (L-L₁)/L is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

The value of C usually impairs the safety performance and kinetic performance of the lithium-ion battery. From Examples 1-1, 1-6, 1-7, 1-18, 1-27, and 1-28, it can be seen that when the value of C is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

The value of D usually impairs the safety performance and kinetic performance of the lithium-ion battery. From Examples 1-1, 1-2 to 1-5, 1-8, 1-9, and 1-18, it can be seen that when the value of D is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

The value of h usually impairs the safety performance and kinetic performance of the lithium-ion battery. From Examples 1-1, 1-10, 1-11, 1-19, and 1-20, it can be seen that when the value of h is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, increasing the winding yield of the secondary battery, and improving the wettability of the electrolyte to the single-sided region negative electrode sheet. Consequently, the lithium-ion battery has good kinetic performance and safety performance.

The value of d usually impairs the safety performance and kinetic performance of the lithium-ion battery. From Examples 1-1, 1-12, 1-13, 1-21, and 1-22, it can be seen that when the value of d is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, improving the wettability of the electrolyte to the single-sided region negative electrode sheet, and increasing the winding yield of the secondary battery. Consequently, the lithium-ion battery has good kinetic performance and safety performance.

The value of L₂ usually impairs the safety performance and kinetic performance of the lithium-ion battery. From Examples 1-1, 1-14, 1-15, 1-23, and 1-24, it can be seen that when the value of L₂ is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

The value of a usually impairs the safety performance and kinetic performance of the lithium-ion battery. From Examples 1-1, 1-16, 1-17, 1-25, and 1-26, it can be seen that when the value of a is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

The value of S₁/S₂ usually impairs the safety performance and kinetic performance of the lithium-ion battery. From Examples 1-1, 1-6, 1-7, 1-12 to 1-15, 1-18, 1-21 to 1-24, 1-27, and 1-28, it can be seen that when the value of S₁/S₂ is within the range of the present application, the maximum rate of low-temperature kinetics in the single-sided negative electrode material layer region is higher, the winding yield related to feeding folding/single-sided negative electrode material layer region strip breakage is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, the lithium-ion battery has good kinetic performance and safety performance.

TABLE 2

| | | | | | | | Winding yield | | 500-cycle capacity |
|---|---|---|---|---|---|---|---|---|---|
| | | | | | | | related to | | retention rate and |
| | | | | | | Maximum rate of | feeding folding/ | | interface |
| | | | | | | low-temperature | single-sided | | characteristics of |
| | | | | | | kinetics in single- | negative electrode | | single-sided |
| | | m | | | | sided negative | material layer | Energy | negative electrode |
| | H | (mg/1540.25 | | PD₁ | PD₂ | electrode material | region strip | density | material layer |
| | (μm) | mm²) | PD₁/PD₂ | (g/cm³) | (g/cm³) | layer region (C.) | breakage (%) | level | region |
| Example | 6 | 150 | 0.98 | 1.70 | 1.73 | 3 | 98 | medium | 88.5%, no |
| 1-1 | | | | | | | | | abnormality in |
| | | | | | | | | | interface |
| Example | 4 | 150 | 0.98 | 1.70 | 1.73 | 3 | 92 | high | 82.5%, no |
| 2-1 | | | | | | | | | abnormality in |
| | | | | | | | | | interface |
| Example | 8 | 150 | 0.98 | 1.70 | 1.73 | 3 | 99.5 | low | 90%, no |
| 2-2 | | | | | | | | | abnormality in |
| | | | | | | | | | interface |
| Example | 6 | 100 | 0.98 | 1.70 | 1.73 | 3.5 | 98.5 | medium- | 89%, no |
| 2-3 | | | | | | | | low | abnormality in |
| | | | | | | | | | interface |
| Example | 6 | 200 | 0.98 | 1.70 | 1.73 | 2 | 96 | medium- | 86.5%, no |
| 2-4 | | | | | | | | high | abnormality in |
| | | | | | | | | | interface |
| Example | 6 | 150 | 0.95 | 1.64 | 1.73 | 3.3 | 98.5 | medium | 89%, no |
| 2-5 | | | | | | | | | abnormality in |
| | | | | | | | | | interface |
| Example | 6 | 150 | 1 | 1.73 | 1.73 | 2.5 | 97 | medium | 87%, no |
| 2-6 | | | | | | | | | abnormality in |
| | | | | | | | | | interface |
| Example | 3 | 150 | 0.98 | 1.70 | 1.73 | 2.7 | 80 | high | 81.2%, no |
| 2-7 | | | | | | | | | abnormality in |
| | | | | | | | | | interface |
| Example | 9 | 150 | 0.98 | 1.70 | 1.73 | 3.3 | 99 | / | 87.4%, no |
| 2-8 | | | | | | | | | abnormality in |
| | | | | | | | | | interface |
| Example | 6 | 90 | 0.98 | 1.70 | 1.73 | 4 | 99.5 | / | 84.1%, no |
| 2-9 | | | | | | | | | abnormality in |
| | | | | | | | | | interface |
| Example | 6 | 210 | 0.98 | 1.70 | 1.73 | 1.7 | 93 | medium- | 85.2%, no |
| 2-10 | | | | | | | | high | abnormality in |
| | | | | | | | | | interface |
| Example | 6 | 150 | 0.9 | 1.56 | 1.73 | 4 | 99 | medium | 79.4%, lithium |
| 2-11 | | | | | | | | | plating in interface |

Note:
“/” in Table 2 indicates no relevant effect parameters.

The value of H usually impairs the safety performance, energy density, and kinetic performance of the lithium-ion battery. From Examples 1-1, 2-1 to 2-2, 2-7 to 2-8, it can be seen that when the value of H is within the range of the present application, the maximum rate of low-temperature kinetics in the single-sided negative electrode material layer region is higher, the winding yield related to feeding folding/single-sided negative electrode material layer region strip breakage is higher, the energy density is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, while maintaining the energy density of the lithium-ion battery, the lithium-ion battery has good kinetic performance and safety performance. Among them, in Example 2-8, the value of H is larger, and at this time, in a lithium-ion battery of the same volume specification, the energy density is relatively lower.

The value of m usually impairs the safety performance, energy density, and kinetic performance of the lithium-ion battery. From Examples 1-1, 2-3 to 2-4, 2-9 to 2-10, it can be seen that when the value of m is within the range of the present application, the maximum rate of low-temperature kinetics in the single-sided negative electrode material layer region is higher, the winding yield related to feeding folding/single-sided negative electrode material layer region strip breakage is higher, the energy density is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, while maintaining the energy density of the lithium-ion battery, the lithium-ion battery has good kinetic performance and safety performance. Among them, in Example 2-9, the value of m is smaller, and at this time, in a lithium-ion battery of the same volume specification, the energy density is relatively lower.

The values of PD₁/PD₂ and PD₂ usually impair the safety performance, energy density, and kinetic performance of the lithium-ion battery. From Examples 1-1, 2-5 to 2-6, 2-11, it can be seen that when the values of PD₁/PD₂ and PD₂ are within the range of the present application, the maximum rate of low-temperature kinetics in the single-sided negative electrode material layer region is higher, the winding yield related to feeding folding/single-sided negative electrode material layer region strip breakage is higher, the energy density is higher, the 500-cycle capacity retention rate is higher, and the interface characteristics of the single-sided negative electrode material layer region are better. These improvements indicate that the curling of the single-sided region negative electrode sheet is mitigated, thereby reducing the risk of strip breakage and feeding folding of the single-sided region negative electrode sheet during actual processing, and increasing the winding yield of the secondary battery. Consequently, while maintaining the energy density of the lithium-ion battery, the lithium-ion battery has good kinetic performance and safety performance.

It should be noted that in this document, relational terms such as first and second are only used to distinguish one entity or operation from another entity or operation, and do not necessarily require or imply any such actual relationship or order between these entities or operations. Moreover, the terms “comprise”, “include”, or any other variation thereof are intended to cover non-exclusive inclusion, so that a process, method, or article that includes a series of elements not only includes those elements but also includes other elements not explicitly listed, or also includes elements inherent to such process, method, or article.

The various embodiments in this specification are described in a related manner, and the same and similar parts between the various embodiments can be referred to each other. The description of each embodiment focuses on the differences from other embodiments.

The above are only preferred embodiments of the present application and are not intended to limit the present application. Any modification, equivalent replacement, improvement, and the like made within the spirit and principles of the present application should be included in the protection scope of the present application.

What is claimed is:

1. A negative electrode sheet, comprising a negative electrode current collector and a negative electrode material layer; wherein, along a length direction of the negative electrode sheet, the negative electrode sheet comprises a blank foil region and a single-sided negative electrode material layer region connected to the blank foil region; and based on a length of the negative electrode sheet, a length proportion of the blank foil region is A, and a length proportion of the single-sided negative electrode material layer region is B, wherein 1/60≤A≤1/11, and 1/20≤B≤1/5; and
a plurality of grooves are provided on the negative electrode material layer in the single-sided negative electrode material layer region, and the plurality of grooves are spaced apart along the length direction of the negative electrode sheet.

2. The negative electrode sheet according to claim 1, wherein 1/30≤A≤1/11; and/or 1/14≤B≤1/5.

3. The negative electrode sheet according to claim 1, wherein, along a thickness direction of the negative electrode sheet, a single groove has an orthographic projection on the negative electrode material layer; along the length direction of the negative electrode sheet, a length of the single-sided negative electrode material layer region is L mm; and the negative electrode sheet further comprises a double-sided negative electrode material layer region, wherein the single-sided negative electrode material layer region and the double-sided negative electrode material layer region have a boundary line, a shortest distance between an outer contour of the orthographic projection of each groove and the boundary line is Li mm, and 1/2≤(L-L₁)/L≤1.

4. The negative electrode sheet according to claim 3, wherein, along a width direction of the negative electrode sheet, the single-sided negative electrode material layer region comprises a middle region and two edge regions connected to the middle region, wherein the plurality of grooves are distributed at intervals in the two edge regions and separately extend through the two edge regions; and based on a width of the negative electrode material layer in the single-sided negative electrode material layer region, a length proportion of the middle region is C, and 0%≤C≤30%.

5. The negative electrode sheet according to claim 1, satisfying at least one of the following characteristics:
(1) the negative electrode current collector comprises a copper foil, and a thickness of the copper foil is H m, wherein 4≤H≤8; or
(2) a coating weight per unit area of the negative electrode material layer in the single-sided negative electrode material layer region is m mg/1540.25 mm², wherein 100≤m≤200.

6. The negative electrode sheet according to claim 1, wherein, along a width direction of the negative electrode sheet, a width of the negative electrode sheet is D mm; and along the length direction of the negative electrode sheet, a length of the single-sided negative electrode material layer region is L mm, wherein 1≤L/D≤2, and 50≤D≤130.

7. The negative electrode sheet according to claim 1, wherein the negative electrode sheet further comprises a double-sided negative electrode material layer region, the negative electrode material layer comprises a negative electrode active material, and the negative electrode active material comprises at least one of graphite or a silicon-carbon composite material; wherein a compacted density of the negative electrode material layer in the single-sided negative electrode material layer region is PD₁ g/cm³, a compacted density of the negative electrode material layer in the double-sided negative electrode material layer region is PD₂ g/cm³, and 0.95≤PD₁/PD₂≤1.

8. The negative electrode sheet according to claim 7, wherein 1.5≤PD₂≤1.8.

9. The negative electrode sheet according to claim 1, wherein, along a thickness direction of the negative electrode sheet, an average depth of the plurality of grooves is h m, wherein 5≤h≤30.

10. The negative electrode sheet according to claim 1, wherein the plurality of grooves are distributed in a strip shape; and along the thickness direction of the negative electrode sheet, each groove has an orthographic projection on the negative electrode material layer, satisfying at least one of the following conditions:
(1) an average width of the orthographic projections of the plurality of grooves is d m, wherein 50≤d≤110; or
(2) a shortest distance between outer contours of the orthographic projections of two adjacent grooves is L₂ mm, wherein 0.5≤L₂≤1.5.

11. The negative electrode sheet according to claim 10, wherein an included angle between a center line of each groove and the length direction of the negative electrode sheet is α°, wherein 20≤α≤75.

12. The negative electrode sheet according to claim 11, wherein, along the thickness direction of the negative electrode sheet, a total area of the orthographic projections of the plurality of grooves is S₁ mm², a projected area of the single-sided negative electrode material layer region is S₂ mm², and 2%≤S₁/S₂≤10%.

13. A secondary battery, comprising a negative electrode sheet, wherein the negative electrode sheet comprises a negative electrode current collector and a negative electrode material layer;
wherein, along a length direction of the negative electrode sheet, the negative electrode sheet comprises a blank foil region and a single-sided negative electrode material layer region connected to the blank foil region; and based on a length of the negative electrode sheet, a length proportion of the blank foil region is A, and a length proportion of the single-sided negative electrode material layer region is B, wherein 1/60≤A≤1/11, and 1/20≤B≤1/5; and
a plurality of grooves are provided on the negative electrode material layer in the single-sided negative electrode material layer region, and the plurality of grooves are spaced apart along the length direction of the negative electrode sheet.

14. The secondary battery according to claim 13, wherein 1/30≤A≤1/11; and/or 1/14≤B≤1/5.

15. The secondary battery according to claim 13, wherein the secondary battery has a wound structure, and the blank foil region is located at a starting end of the wound structure.

16. The secondary battery according to claim 13, wherein, along a thickness direction of the negative electrode sheet, a single groove has an orthographic projection on the negative electrode material layer; along the length direction of the negative electrode sheet, a length of the single-sided negative electrode material layer region is L mm; and the negative electrode sheet further comprises a double-sided negative electrode material layer region, wherein the single-sided negative electrode material layer region and the double-sided negative electrode material layer region have a boundary line, a shortest distance between an outer contour of the orthographic projection of each groove and the boundary line is Li mm, and 1/2≤(L-L₁)/L≤1.

17. The secondary battery according to claim 13, wherein, along a width direction of the negative electrode sheet, the single-sided negative electrode material layer region comprises a middle region and two edge regions connected to the middle region, wherein the plurality of grooves are distributed at intervals in the two edge regions and separately extend through the two edge regions; and based on a width of the negative electrode material layer in the single-sided negative electrode material layer region, a length proportion of the middle region is C, and 0%≤C≤30%.

18. The secondary battery according to claim 13, satisfying at least one of the following characteristics:
(1) the negative electrode current collector comprises a copper foil, and a thickness of the copper foil is H m, wherein 4≤H≤8; or
(2) a coating weight per unit area of the negative electrode material layer in the single-sided negative electrode material layer region is m mg/1540.25 mm², wherein 100≤m≤200.

19. The secondary battery according to claim 13, wherein, along a width direction of the negative electrode sheet, a width of the negative electrode sheet is D mm; and along the length direction of the negative electrode sheet, a length of the single-sided negative electrode material layer region is L mm, wherein 1≤L/D≤2, and 50≤D≤130.

20. An electronic device, comprising a secondary battery, wherein the secondary battery comprises a negative electrode sheet;
wherein the negative electrode sheet comprises a negative electrode current collector and a negative electrode material layer;
wherein, along a length direction of the negative electrode sheet, the negative electrode sheet comprises a blank foil region and a single-sided negative electrode material layer region connected to the blank foil region; and based on a length of the negative electrode sheet, a length proportion of the blank foil region is A, and a length proportion of the single-sided negative electrode material layer region is B, wherein 1/60≤A≤1/11, and 1/20≤B≤1/5; and
a plurality of grooves are provided on the negative electrode material layer in the single-sided negative electrode material layer region, and the plurality of grooves are spaced apart along the length direction of the negative electrode sheet.
